(19) United States
(12) Patent Application Publication
(10) Pub. No.: US 2025/0172337 A1
(43) Pub. Date: May 29, 2025

(54) DRYING DEVICE AND RECORDING DEVICE

(71) Applicant: SEIKO EPSON CORPORATION, Tokyo (JP)

(72) Inventors: Tadashi AIZAWA, MATSUMOTO-SHI (JP); Tsuneyuki SASAKI, MATSUMOTO-SHI (JP)

(21) Appl. No.: 18/959,804

(22) Filed: Nov. 26, 2024

(30) Foreign Application Priority Data
Nov. 29, 2023 (JP) 2023-201432

(51) Int. Cl. F26B 3/347; B41J 3/407; B41J 11/00; B41J 29/377

(52) U.S. Cl. CPC F26B 3/347; B41J 3/4078; B41J 11/00218; B41J 29/377

(57) ABSTRACT

A drying device includes a drying section that dries a medium onto which liquid was ejected by generating an electromagnetic wave in response to application of a high-frequency voltage, and a gas intake section that takes in gas. The drying section includes a first electrode, a second electrode arranged so as to surround the first electrode in plan view from a first direction toward a medium, a first conductor that includes a coil and that electrically connects a transmission line, which is configured to transmit a high-frequency voltage and the first electrode, and a second conductor that electrically connects the transmission line and the second electrode. The gas intake section includes a gas intake port that takes in gas evaporated from a medium onto which liquid has been ejected.

The present application is based on, and claims priority from JP Application Serial Number 2023-201432, filed Nov. 29, 2023, the disclosure of which is hereby incorporated by reference herein in its entirety.

### BACKGROUND

### 1. Technical Field

The present disclosure relates to a drying device and a recording device.

### 2. Related Art

For example, a drying device that dries a medium by generating electromagnetic waves on a medium onto which liquid has been ejected, such as JP-A-2017-16742, has been disclosed. Such a drying device generates electromagnetic waves with respect to a medium by supplying a high-frequency voltage between a first electrode and a second electrode. By this, the medium can be dried by boiling liquid ejected onto the medium, regardless of whether or not water vapor is saturated around the medium.

However, in such a drying device, when gas containing boiled liquid cools, there is a possibility that liquid contained in the gas condenses. In this way, condensed liquid may drip onto a medium. Therefore, it is desired to dry a medium without lowering the recording quality of a medium.

### SUMMARY

A drying device to overcome the above-described problem includes a drying section that dries a medium onto which liquid was ejected, by generating an electromagnetic wave in response to application of a high-frequency voltage and a gas intake section that takes in gas, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the gas intake section includes a gas intake port that takes in gas evaporated from a medium onto which liquid has been ejected.

A recording device to overcome the above-described problem includes a recording section that performs recording by ejecting liquid onto a medium; a drying section that dries a medium onto which liquid was ejected by the recording section, by generating an electromagnetic wave in response to application of a high-frequency voltage; and a gas intake section that takes in gas, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the gas intake section includes a gas intake port that takes in gas evaporated from a medium onto which liquid has been ejected.

### BRIEF DESCRIPTION OF THE DRAWINGS

FIG. 1 is a schematic diagram showing a recording system of a first embodiment.

FIG. 2 is a perspective view showing a drying section and a gas intake section of the first embodiment.

FIG. 3 is a top view showing the drying section and the gas intake section of the first embodiment.

FIG. 4 is a perspective view showing the drying section of the first embodiment.

FIG. 5 is a flowchart showing a drying control process of the first embodiment.

FIG. 6 is a schematic diagram showing a drying section, a gas intake section, and a blower section of a second embodiment.

FIG. 7 is a schematic diagram showing the drying section, the gas intake section, and the blower section of the second embodiment.

FIG. 8 is a schematic diagram showing a drying section, a gas intake section, and a blower section of a third embodiment.

### DESCRIPTION OF EMBODIMENTS

### First Embodiment

Hereinafter, an embodiment of a recording system including a drying device and a recording device will be described. In the following description, a direction intersecting a vertical direction Z is referred to as a width direction X, and a direction intersecting the vertical direction Z and the width direction X is referred to as a depth direction Y. One direction along the width direction X is referred to as a first width direction X1, and the other direction along the width direction X is referred to as a second width direction X2. One direction along the depth direction Y is referred to as a first depth direction Y1, and the other direction along the depth direction Y is referred to as a second depth direction Y2. In the vertical direction Z, an upper direction is referred to as an upper direction Z1, and a lower direction is referred to as a lower direction Z2. The vertical direction Z corresponds to an example of a first direction. The width direction X corresponds to an example of a second direction. The depth direction Y corresponds to an example of a third direction.

### Configuration of Recording System 10

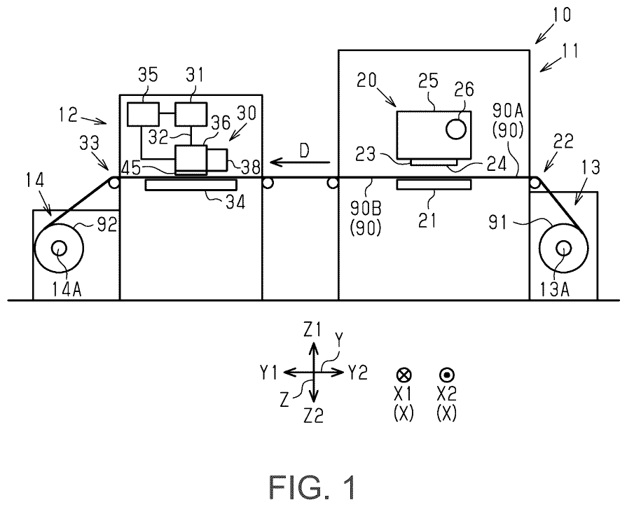

As shown in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 on which recording has been performed by ejecting liquid.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet type printer that performs recording by ejecting ink, which is an example of liquid, onto the medium 90. The medium 90 includes a front surface 90A and a back surface 90B. The medium 90 is fabric, but may be, for example, paper.

The recording system 10 includes a drying device 12. The drying device 12 is configured to dry the medium 90 after recording onto which the recording device 11 has ejected liquid. In particular, the drying device 12 generates electromagnetic waves to dry the medium 90 after recording.

The recording system 10 includes a feeding section 13. The feeding section 13 feeds the medium 90 to the recording device 11 before recording. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 before recording which is wound and stacked. The medium 90 may be elongated. In this way, the feed roller 13A holds the medium 90 to be fed to the recording device 11.

The recording system 10 includes a winding section 14. The winding section 14 winds up the medium 90 after recording by the recording device 11. In particular, the winding section 14 winds up the medium 90 after recording and drying by the drying device 12. The winding section 14 includes a winding roller 14A. The winding roller 14A is extended along the width direction X. In the width direction X, the width of the winding roller 14A is longer than the width of the medium 90. The winding roller 14A is configured to rotatably hold a second roll body 92. The second roll body 92 is the medium 90 after recording which is wound and stacked. In this way, the winding roller 14A winds up the medium 90 that has been recorded by the recording device 11 and dried by the drying device 12.

### Configuration of Recording Device 11

Here, the configuration of the recording device 11 will be described in detail.

The recording device 11 includes a recording section 20, a recording support section 21, and a recording transport section 22. The recording section 20 is configured to perform recording on the medium 90 by ejecting liquid onto the medium 90. The recording section 20 is configured to perform recording on the medium 90 by ejecting liquid onto the front surface 90A of the medium 90. The recording section 20 performs recording on the medium 90 supported by the recording support section 21. The recording section 20 performs recording on the medium 90 transported by the recording transport section 22.

The recording section 20 includes a head 23. The head 23 may be a serial head or may be a line head. A serial head is a head that scans in the width direction X of the medium 90. A line head is a head that records simultaneously across the width direction X of the medium 90.

The head 23 includes a nozzle surface 24 in which a plurality of nozzles (not shown) is opened. The nozzle surface 24 is a surface facing the lower direction Z2. The nozzle surface 24 is a surface facing the front surface 90A of the medium 90 transported by the recording transport section 22. Each of the plurality of nozzles is configured to open up in the lower direction Z2. Each of the plurality of nozzles is configured to eject liquid.

The recording section 20 may include a recording carriage 25 and a recording carriage support section 26. The recording carriage 25 is configured to support the head 23. The recording carriage support section 26 is extended along the width direction X. The recording carriage support section 26 supports the recording carriage 25 so as to be movable along the width direction X. The recording carriage 25 is movable in the width direction X along the recording carriage support section 26 by a driving force from a drive source (not shown).

The recording support section 21 is configured to support the medium 90 transported by the recording transport section 22. The recording support section 21 is positioned in the lower direction Z2 of the recording section 20. The recording support section 21 supports the back surface 90B of the medium 90 transported by the recording transport section 22. The recording support section 21 is positioned in the lower direction Z2 of the head 23.

The recording transport section 22 is configured to transport the medium 90 in a transport direction D. The transport direction D is a direction along the depth direction Y. The recording transport section 22 may include a plurality of rollers. Although the recording transport section 22 transports the medium 90 in the transport direction D using the plurality of rollers, the recording transport section 22 may transport the medium 90 in the transport direction D using a transport belt driven by a plurality of rollers. The recording transport section 22 may perform intermittent transport in which the transport and stop of the medium 90 are repeated.

### Configuration of Drying Device 12

Next, the configuration of the drying device 12 will be described in detail.

The drying device 12 includes a drying unit 30. The drying unit 30 is configured to dry the medium 90 after recording. That is, the drying device 12 sets the medium 90 on which recording is performed by the recording section 20 as an object to be dried.

The drying unit 30 is configured to dry the medium 90 after recording by generation of electromagnetic waves. The drying unit 30 is positioned in the upper direction Z1 of the medium 90, but may be positioned in the lower direction Z2 of the medium 90, or may be positioned both in the upper direction Z1 and in the lower direction Z2 of the medium 90. In this way, the vertical direction Z is a direction toward the medium 90.

The drying device 12 includes a high-frequency voltage generation section 31. The high-frequency voltage generation section 31 is configured to generate a high-frequency voltage. The high-frequency voltage generation section 31 supplies a high-frequency voltage to the drying unit 30 through a transmission line 32.

The transmission line 32 is a line that connects the drying unit 30 and the high-frequency voltage generation section 31. The transmission line 32 is capable of transmitting a high-frequency voltage from the high-frequency voltage generation section 31 to the drying unit 30. That is, the transmission line 32 is capable of transmitting a high-frequency voltage.

The transmission line 32 may be a coaxial cable, but is not limited to coaxial cable. The transmission line 32 may include a first line and a second line. The first line may be a core line of the transmission line 32. The second line may be an electromagnetic shield that covers the first line.

The drying device 12 includes a drying transport section 33. The drying transport section 33 is configured to transport the medium 90 in the transport direction D. The drying transport section 33 may transport the medium 90 in the transport direction D using a plurality of rollers. The drying transport section 33 may perform continuous transport for continuously transporting the medium 90. Slackening of the medium 90 may occur between the recording transport section 22 and the drying transport section 33.

The drying device 12 includes a drying support section 34. The drying support section 34 is configured to support the medium 90 transported by the drying transport section 33. The drying support section 34 is positioned in the lower direction Z2 of the drying unit 30. The drying support section 34 supports the back surface 90B of the medium 90 transported by the drying transport section 33. The drying support section 34 is positioned in the lower direction Z2 of the drying section 36 (to be described later).

The drying device 12 includes a control section 35. The control section 35 controls the drying device 12. Specifically, the control section 35 controls the drying unit 30. In particular, the control section 35 controls a drying section 36, a gas intake section 37, and a drying carriage 38, which will be described later, as the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be composed of one or more dedicated hardware circuits. The control section 35 may be configured with an application specific integrated circuit that executes at least a part of various processes. The control section 35 may be composed of a processor and a circuit including a combination of hardware circuits. The processor includes a CPU and memories such as a RAM and a ROM. The memory stores program codes or instructions configured to cause the CPU to perform processes. Memory, that is computer-readable medium, includes any readable medium that can be accessed by a general-purpose or dedicated computer.

### Configuration of Drying Unit 30

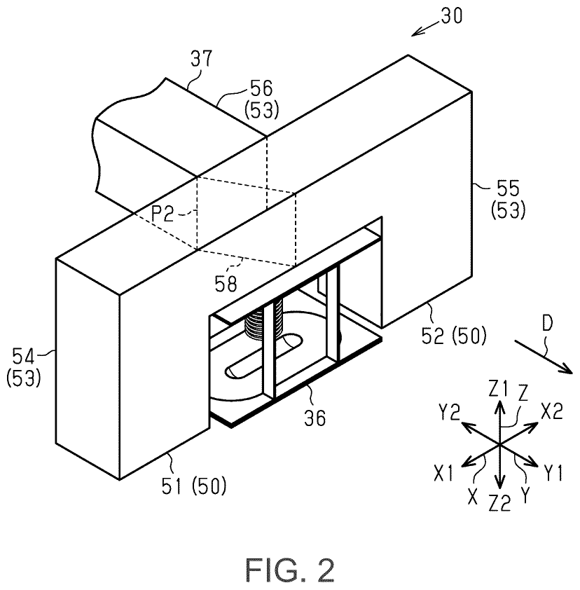

Next, the structure of the drying unit 30 will be described with reference to FIGS. 2 to 4.

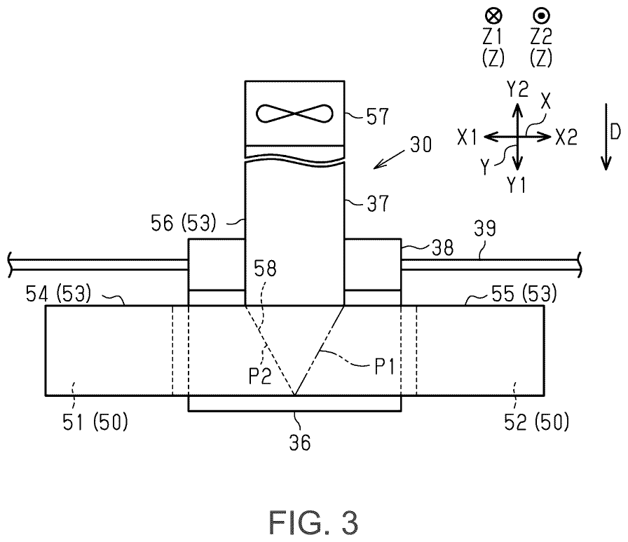

As shown in FIGS. 2 and 3, the drying unit 30 includes a drying section 36. That is, the drying device 12 includes the drying section 36. The drying section 36 may have a rectangular shape in plan view from the vertical direction Z. The drying section 36 may be arranged so that the width direction X is a longitudinal direction.

The drying section 36 is configured to generate an electromagnetic wave in response to application of a high-frequency voltage. The drying section 36 generates an electromagnetic wave in response to application of a high-frequency voltage. By this, the drying section 36 is configured to dry the medium 90 onto which liquid has been ejected by the recording section 20. The drying section 36 is an electromagnetic wave generation section.

The drying section 36 generates an alternating current electric field by generating an electromagnetic wave. An electromagnetic wave generated by the drying section 36 has an electric field as a main component. The drying section 36 can significantly reduce induction of a magnetic field due to a generated electric field as compared with an electromagnetic wave generation section that generates a normal electromagnetic wave.

As a specific example, the drying section 36 generates electromagnetic waves of 2.4 GHz, but is not limited to this. The drying section 36 may generate, for example, electromagnetic waves of 3 MHz to 300 MHz. The drying section 36, for example, may generate electromagnetic waves of 300 MHz to 30 GHz, and among these, may generate electromagnetic waves of 10 MHz to 20 GHz.

The drying section 36 dries the medium 90 by heating the medium 90 from the front surface 90A. Specifically, the drying section 36 heats liquid ejected onto the medium 90 from the front surface 90A. The drying section 36 dries the medium 90 by evaporating liquid ejected onto the medium 90. That is, the drying section 36 is a method of drying the medium 90 regardless of whether or not water vapor is saturated around the medium 90. Therefore, the drying section 36 does not need to blow dry gas in which water vapor is not saturated around the medium 90. Configuration of drying section 36

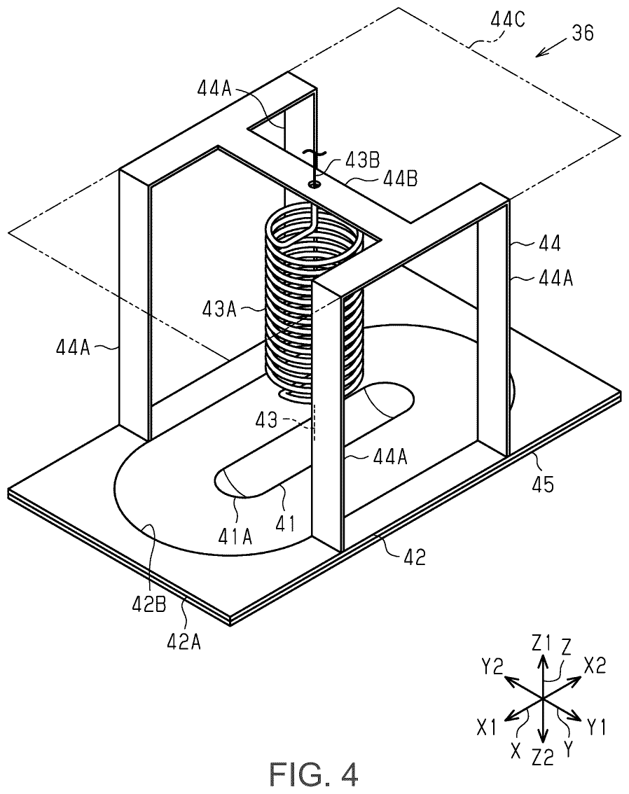

As shown in FIG. 4, the drying section 36 includes a first electrode 41, a second electrode 42, a first conductor 43, and a second conductor 44. The drying section 36 may include a facing section 45. FIG. 3 is a diagram excluding a top plate 44C of the second conductor 44 for convenience. FIG. 4 is a view in which the first electrode 41 and second electrode 42 are arranged on a lower direction Z2 side.

The first electrode 41 has a flat plate shape. The first electrode 41 may have a rectangular shape in which the width direction X is a longitudinal direction in plan view. The first electrode 41 includes a first electrode surface 41A. The first electrode surface 41A is a surface facing the lower direction Z2. That is, the first electrode surface 41A is a surface facing the front surface 90A of the medium 90. The first electrode 41 is arranged so that the first electrode surface 41A abuts the facing section 45.

The second electrode 42 has a flat plate shape. The second electrode 42 includes a second electrode surface 42A. The second electrode surface 42A is a surface facing the lower direction Z2. That is, the second electrode surface 42A is a surface facing the front surface 90A of the medium 90. The second electrode 42 is arranged such that the second electrode surface 42A abuts the facing section 45.

The second electrode 42 includes an opening section 42B. The opening section 42B has a rectangular shape with rounded corners in plan view. The first electrode 41 is positioned in the opening section 42B. That is, the second electrode 42 is arranged so as to surround the first electrode 41 in plan view from the vertical direction Z.

The first conductor 43 is configured to electrically connect the transmission line 32 and the first electrode 41. The first conductor 43 includes a coil 43A. The coil 43A extends in the vertical direction Z. One end of the coil 43A is connected to the first electrode 41. The other end of the coil 43A is connected to the conductor wire 43B.

The second conductor 44 is configured to electrically connect the transmission line 32 and the second electrode 42. The second conductor 44 may include a columnar support 44A. The second conductor 44 may include a plurality of columnar supports 44A. The columnar supports 44A are electrically connected to the second electrode 42. The columnar supports 44A extend from the second electrode 42 to the upper direction Z1. The columnar support 44A is made of metal.

The second conductor 44 may include a connection section 44B. The connection section 44B is electrically connected to the columnar supports 44A. The connection section 44B is provided at an upper end section of the columnar supports 44A. The connection section 44B connects a plurality of columnar supports 44A. The connection section 44B may be integral with the columnar support 44A. The connection section 44B may be H-shaped in plan view. The connection section 44B is made of metal.

The second conductor 44 may include the top plate 44C. The top plate 44C is positioned in the upper direction Z1 of the connection section 44B. The top plate 44C is electrically connected to the connection section 44B. The top plate 44C may be integral with the connection section 44B. The top plate 44C is made of metal.

The facing section 45 is positioned between the first electrode 41 and the second electrode 42, and the medium 90. The facing section 45 may have a flat plate shape. The facing section 45 is made of a material that transmits electromagnetic waves generated by the drying section 36. The facing section 45 is arranged so as to face the front surface 90A of the medium 90. The facing section 45 may not be in contact with the medium 90, and may be in contact with the medium 90. The facing section 45 protects the first electrode 41 and the second electrode 42. The facing section 45 is composed of a member having insulating properties. The facing section 45 may be a glass plate. The facing section 45 may be a ceramic with high transmittance. The facing section 45 may be made of a resin with a low dissipation factor. The facing section 45 may be made of polypropylene. The facing section 45 may be made of polyethylene.

By configuring the drying section 36 in this manner, when a high-frequency voltage is applied, the first electrode 41 and the second electrode 42 heat the medium 90 by generating an electromagnetic wave in response to application of a high-frequency voltage.

Such a drying section 36 can transmit a large amount of thermal energy to the medium 90 due to generation of electromagnetic waves. The drying section 36 is not of a thermal conduction type but of an electromagnetic wave type, and may not include a member such as a heating wire for heating. This allows the drying section 36 to be made smaller in size.

The minimum separation distance between the first electrode 41 and the second electrode 42 is equal to or less than 1/10 of the wavelength of an electromagnetic wave output from the drying section 36. By this, electromagnetic waves generated when a high-frequency voltage is applied can be attenuated in the vicinity of the first electrode 41 and the second electrode 42. By this, it is possible to reduce the intensity of an electromagnetic wave that reaches a distant place from the first electrode 41 and the second electrode 42. That is, an electromagnetic wave generated from the drying section 36 is very strong in the vicinity of the first electrode 41 and the second electrode 42, and is very weak in a distant place.

Such a drying section 36 can intensively generate an alternating current electric field in the vicinity of the first electrode 41 and the second electrode 42 by appropriately controlling the frequency band of an electromagnetic wave to be generated. In other words, it is possible to suppress the influence on the surroundings accompanying the generation of electromagnetic waves beyond the vicinity of the first electrode 41 and the second electrode 42. The vicinity of the first electrode 41 and the second electrode 42 may correspond to a range of, for example, 3 mm to 3 cm.

### Configuration of Gas Intake Section 37

As shown in FIGS. 2 and 3, the drying unit 30 includes a gas intake section 37. The gas intake section 37 is configured to take in gas. In particular, the gas intake section 37 is configured to take in liquid evaporated from the medium 90 when the medium 90 is dried by the drying section 36.

The gas intake section 37 includes a gas intake port 50. The gas intake port 50 takes in gas evaporated from the medium 90 onto which liquid has been ejected. The gas intake port 50 includes a first gas intake port 51 and a second gas intake port 52. The first gas intake port 51 is provided further in the first width direction X1 than the drying section 36. The second gas intake port 52 is provided further in the second width direction X2 than the drying section 36. That is, the drying section 36 is provided between the first gas intake port 51 and the second gas intake port 52 in the width direction X.

The gas intake section 37 includes a gas intake pipe 53. The gas intake pipe 53 is a pipe communicating with the gas intake port 50. The gas intake pipe 53 may include a first gas intake pipe 54, a second gas intake pipe 55, and a common gas intake pipe 56. The first gas intake pipe 54 is a pipe communicating with the first gas intake port 51. The second gas intake pipe 55 is a pipe communicating with the second gas intake port 52. The common gas intake pipe 56 is a pipe communicating with the first gas intake pipe 54 and the second gas intake pipe 55 at a position where the first gas intake pipe 54 and the second gas intake pipe 55 intersect. The common gas intake pipe 56 is a pipe communicating with a gas intake fan 57 (to be described later). Part or all of the common gas intake pipe 56 may be provided by a flexible member such as a hose. In particular, when the gas intake section 37 moves in the width direction X, it is desirable that the common gas intake pipe 56 includes a flexible member having a sufficient length so as not to interfere with the movement of the gas intake section 37.

As shown in FIG. 3, the gas intake section 37 includes a gas intake fan 57. The gas intake fan 57 is connected to the gas intake pipe 53. Specifically, the gas intake fan 57 is connected to the common gas intake pipe 56. The gas intake fan 57 is driven so as to take in gas from the gas intake port 50 via the gas intake pipe 53. The gas intake fan 57 is controlled by control section 35.

The gas intake section 37 includes a switching valve 58. The switching valve 58 is provided at a position where the first gas intake pipe 54, the second gas intake pipe 55, and the common gas intake pipe 56 intersect each other. The switching valve 58 is movable between a first position P1 and a second position P2 by a drive section (not shown).

The first position P1 is a position at which the second gas intake pipe 55 and the common gas intake pipe 56 do not communicate with each other and the first gas intake pipe 54 and the common gas intake pipe 56 communicate with each other. The first position P1 is a position at which gas is taken in from the first gas intake port 51. The second position P2 is a position at which the first gas intake pipe 54 and the common gas intake pipe 56 do not communicate with each other and the second gas intake pipe 55 and the common gas intake pipe 56 communicate with each other. The second position P2 is a position at which gas is taken in from the second gas intake port 52.

In this way, the switching valve 58 is configured to switch between taking in gas from the first gas intake port 51 and taking in gas from the second gas intake port 52. The switching valve 58 is controlled by the control section 35.

### Configuration of Drying Carriage 38

The drying unit 30 may include a drying carriage 38 and a drying carriage support section 39. That is, the drying device 12 may include the drying carriage 38. The drying carriage 38 corresponds to an example of a carriage. The drying carriage 38 is configured to support the drying section 36 and the gas intake section 37. That is, the drying section 36 and the gas intake section 37 are provided in the drying carriage 38. The drying carriage support section 39 is extended along the width direction X. The drying carriage support section 39 may be configured with one piece or multiple pieces. The drying carriage support section 39 supports the drying carriage 38 so as to be movable along the width direction X. The drying carriage 38 is configured to be movable in the width direction X along the drying carriage support section 39 by a driving force from a drive source (not shown). Positional relationship in plan view from vertical direction Z

The gas intake port 50 is provided at a position that does not overlap the drying section 36 in plan view from the vertical direction Z. Specifically, the first gas intake port 51 and the second gas intake port 52 are provided at positions that do not overlap the drying section 36 in plan view from the vertical direction Z.

### Drying Control Process

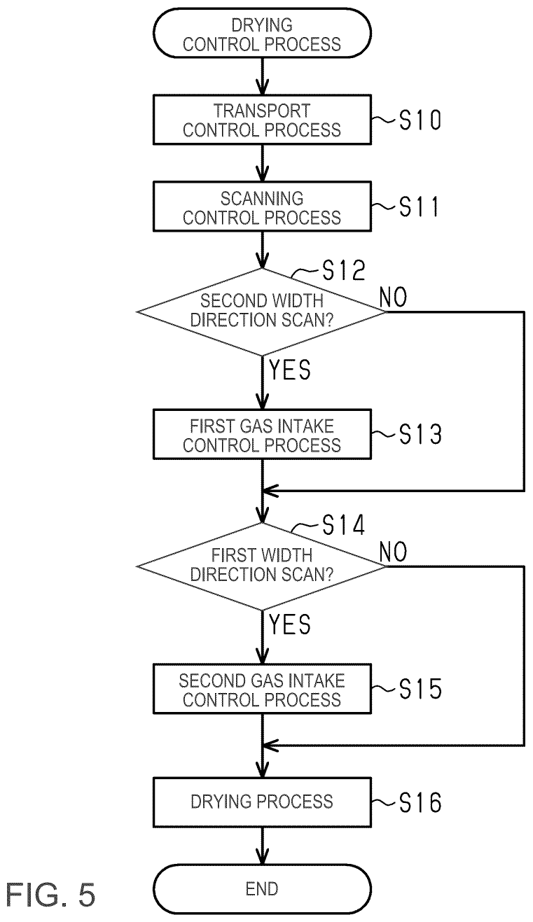

Next, a drying control process will be described with reference to FIG. 5. The drying control process is a process executed at a predetermined cycle by control section 35 when there is a drying instruction from a user.

As shown in FIG. 5, in step S10, the control section 35 executes a transport control process. In this process, the control section 35 controls the drying transport section 33 so as to transport the medium 90 in the transport direction D.

In step S11, control section 35 executes a scanning control process. In this process, the control section 35 controls to move the drying carriage 38 in the width direction X. Specifically, the control section 35 performs control to move the drying carriage 38 in the first width direction X1 so as to straddle the medium 90. Thereafter, the control section 35 performs control to move the drying carriage 38 in the second width direction X2 so as to straddle the medium 90.

In step S12, the control section 35 determines whether or not the drying carriage 38 is scanned in the second width direction X2. When the control section 35 determines that the drying carriage 38 is not scanned in the second width direction X2, the control section 35 shifts the process to step S14. When the control section 35 determines that the drying carriage 38 is scanned in the second width direction X2, the control section 35 shifts the process to step S13.

In step S13, the control section 35 executes a first gas intake control process. In this process, the control section 35 controls the switching valve 58 such that gas is taken in from the first gas intake port 51 without taking in gas from the second gas intake port 52.

In step S14, the control section 35 determines whether or not the drying carriage 38 is scanned in the first width direction X1. When the control section 35 determines that the drying carriage 38 is not scanned in the first width direction X1, the control section 35 shifts the process to step S16. When the control section 35 determines that the drying carriage 38 is scanned in the first width direction X1, the control section 35 shifts the process to step S15.

In step S15, the control section 35 executes a second gas intake control process. In this process, the control section 35 controls the switching valve 58 such that gas is taken in from the second gas intake port 52 without taking in gas from the first gas intake port 51.

In step S16, the control section 35 executes a drying process. In this process, the control section 35 controls the high-frequency voltage generation section 31 to supply a high-frequency voltage to the drying section 36. By this, the control section 35 controls the high-frequency voltage generation section 31 to drive the drying section 36.

In this manner, in a case where the drying carriage 38 is moved along the width direction X, the control section 35 controls the gas intake section 37 so as to take in gas from a gas intake port positioned in a direction opposite to a movement direction of the drying carriage 38, of the first gas intake port 51 and the second gas intake port 52. Specifically, in a case where the drying carriage 38 is moved along the width direction X, the control section 35 controls the switching valve 58 so as to take in gas from a gas intake port positioned in a direction opposite to a movement direction of the drying carriage 38, of the first gas intake port 51 and the second gas intake port 52.

### Operations and Effects of First Embodiment

Operations and effects of the first embodiment will be described.

(1-1) The drying section 36 dries the medium 90 onto which liquid has been ejected by generating a electromagnetic wave in response to application of a high-frequency voltage. The gas intake section 37 includes the gas intake port 50 that takes in gas evaporated from the medium 90 onto which liquid is ejected. According to this configuration, when the medium 90 onto which liquid has been ejected is dried, liquid evaporated from the medium 90 is taken in from the gas intake port 50, so that condensation of liquid evaporated from the medium 90 can be suppressed. By this, it is possible to prevent condensed liquid from falling on the medium 90. Therefore, the medium 90 can be dried without lowering the recording quality of the medium 90.

(1-2) In the related art, when a medium is dried by boiling liquid, when the air reaching the saturated water vapor pressure is filled in the vicinity of the medium, evaporation of the liquid is suppressed. For this reason, it was necessary to continuously blow unsaturated air onto a front surface of the medium. On the other hand, in a case where the medium is dried by dielectric heating accompanying the generation of electromagnetic waves, even when the air reaching the saturated water vapor pressure is filled in the vicinity of the medium, evaporation of the liquid is not suppressed. Therefore, when air is blown to a region where the medium is heated, the temperature of the liquid is lowered, and there is a possibility that the drying efficiency is lowered.

Therefore, the gas intake port 50 is provided at a position which does not overlap the drying section 36 in plan view from the vertical direction Z. According to this configuration, in plan view from the vertical direction Z, a region where the medium 90 is dried by the drying section 36 and a region where gas is taken in from the gas intake port 50 can be configured so as not to overlap each other. By this, a region where the medium 90 is dried by the drying section 36 can be prevented from being cooled gas taken in from the gas intake port 50. Therefore, it is possible to suppress the lowering of the drying efficiency of the medium 90 and to dry the medium 90 without lowering the recording quality of the medium 90.

(1-3) The drying section 36 and the gas intake section 37 are provided in the drying carriage 38. According to this configuration, by moving the drying carriage 38 provided with the drying section 36 and the gas intake section 37 in the width direction X, it is possible to improve the drying efficiency of the medium 90 while reducing the number of the drying sections 36 without causing an increase in size of the drying section 36 and the gas intake section 37.

(1-4) The gas intake port 50 includes the first gas intake port 51 and the second gas intake port 52. The first gas intake port 51 and the second gas intake port 52 are provided at positions that do not overlap the drying section 36 in plan view from the vertical direction Z. The drying section 36 is provided between the first gas intake port 51 and the second gas intake port 52 in the width direction X. According to this configuration, it is possible to provide the first gas intake port 51 and the second gas intake port 52 on both sides with respect to a movement direction of the drying section 36. By this, liquid evaporated from the medium 90 in a movement direction of the drying section 36 can be efficiently taken in. Therefore, the medium 90 can be dried without lowering the recording quality of the medium 90.

(1-5) In a case where the drying carriage 38 is moved along the width direction X, the control section 35 controls the gas intake section 37 so as to take in gas from a gas intake port positioned in a direction opposite to a movement direction of the drying carriage 38, of the first gas intake port 51 and the second gas intake port 52. According to this configuration, gas can be taken in from a gas intake port positioned in a direction opposite to a movement direction of the drying section 36. By this, liquid evaporated from the medium 90 in a direction opposite to a movement direction of the drying section 36 can be efficiently taken in. Therefore, the medium 90 can be dried without lowering the recording quality of the medium 90.

(1-6) The drying section 36 is provided on a front surface 90A side of the medium 90. Therefore, the medium 90 can be dried by heating liquid from a front surface 90A side of the medium 90 onto which liquid has been ejected.

### Second Embodiment

Next, a second embodiment will be described. In the following description, the same configuration as that of the embodiment already described will be omitted or simplified, and a configuration different from that of the embodiment already described will be described.

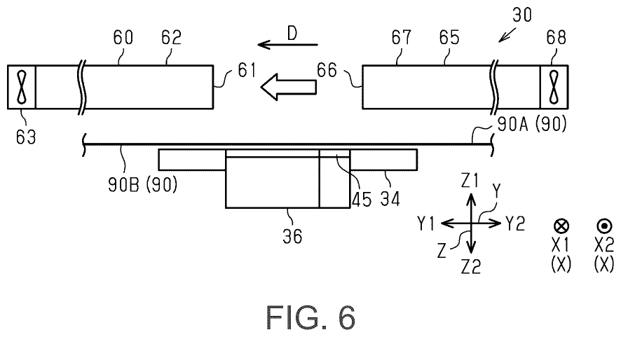

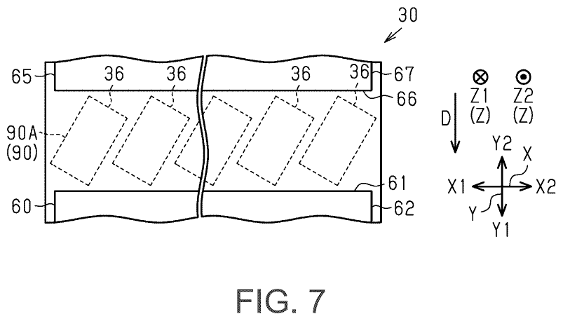

As shown in FIGS. 6 and 7, in the drying device 12 according to the second embodiment, the drying unit 30 may include a plurality of the drying sections 36. In other words, the drying device 12 may include a plurality of the drying sections 36.

Each of the plurality of the drying sections 36 is provided on a back surface 90B side of the medium 90 in the vertical direction Z. In the plurality of the drying sections 36, the first electrode 41, the second electrode 42, and the facing section 45 are arranged on an upper direction Z1 side. As described above, the plurality of the drying sections 36 dry the medium 90 by heating the medium 90 from the back surface 90B.

The plurality of drying sections 36 are provided to be arranged in the width direction X. The plurality of drying sections 36 are provided so as to be inclined at a predetermined angle with respect to the depth direction Y, but may be provided so that the depth direction Y is a longitudinal direction.

The drying support section 34 is provided on both an upstream side and a downstream side of the plurality of drying sections 36 in the transport direction D. The drying support section 34 is not provided between the plurality of drying sections 36 and the back surface 90B of the medium 90. The drying support section 34 may be made of stainless steel.

The drying unit 30 includes a gas intake section 60. That is, the drying device 12 includes the gas intake section 60. The gas intake section 60 is provided on a front surface 90A side of the medium 90 in the vertical direction Z. The gas intake section 60 is provided on a downstream side in the transport direction D.

The gas intake section 60 includes a gas intake port 61. The gas intake port 61 is provided on a front surface 90A side of the medium 90 in the vertical direction Z. The gas intake port 61 opens up at an upstream side in the transport direction D. The gas intake port 61 may be provided at a position that does not overlap the drying section 36 in plan view from the vertical direction Z. The gas intake port 61 may be provided on a downstream side of the drying section 36 in the transport direction D in plan view from the vertical direction Z.

The gas intake port 61 is provided at a position separated from the medium 90 in the vertical direction Z in the upper direction Z1. The gas intake port 61 is provided at a position separated from the drying section 36 in the vertical direction Z in the upper direction Z1. The gas intake port 61 is provided at a position separated in the upper direction Z1 from the drying section 36 with the medium 90 interposed therebetween in the vertical direction Z. In the vertical direction Z, the distance between the gas intake port 61 and the front surface 90A of the medium 90 is longer than the distance between the drying section 36 and the back surface 90B of the medium 90.

The gas intake section 60 includes a first gas guide section 62 and a gas intake fan 63. The first gas guide section 62 extends along the transport direction D. The first gas guide section 62 extends in a downstream direction with respect to the transport direction D from a position where the gas intake port 61 is provided. The first gas guide section 62 is configured to communicate with the gas intake port 61. The first gas guide section 62 is a pipe that communicates with the gas intake port 61. The first gas guide section 62 is a pipe that communicates with the gas intake fan 63. The first gas guide section 62 may constitute a part or the whole of a gas intake pipe.

The drying unit 30 may include a blower section 65. That is, the drying device 12 may include the blower section 65. The blower section 65 is configured to blow gas. The blower section 65 is provided on a front surface 90A side of the medium 90 in the vertical direction Z. The blower section 65 is provided on an upstream side in the transport direction D.

The blower section 65 includes a blower port 66. The blower port 66 is an opening for blowing gas. The blower port 66 is provided on a front surface 90A side of the medium 90 in the vertical direction Z. The blower port 66 opens up on a downstream side in the transport direction D. The blower port 66 may be provided at a position that does not overlap the drying section 36 in plan view from the vertical direction Z. The blower port 66 may be provided on an upstream side of the drying section 36 in the transport direction D in plan view from the vertical direction Z.

The blower port 66 is provided at a position separated from the medium 90 in the vertical direction Z in the upper direction Z1. The blower port 66 is provided at a position separated from the drying section 36 in the vertical direction Z in the upper direction Z1. The blower port 66 is provided at a position separated in the upper direction Z1 from the drying section 36 with the medium 90 interposed therebetween in the vertical direction Z. In the vertical direction Z, the distance between the blower port 66 and the front surface 90A of the medium 90 is longer than the distance between the drying section 36 and the back surface 90B of the medium 90.

The blower section 65 includes a second gas guide section 67 and a blower fan 68. The second gas guide section 67 extends along the transport direction D. The second gas guide section 67 extends in an upstream direction with respect to the transport direction D from a position where the blower port 66 is provided. The second gas guide section 67 is configured to communicate with the blower port 66. The second gas guide section 67 is a pipe that communicates with the blower port 66. The second gas guide section 67 is a pipe that communicates with the blower fan 68. The second gas guide section 67 may constitute a part or the whole of a blower pipe.

### Operations and Effects of Second Embodiment

Operations and effects of the second embodiment will be described.

(2-1) The plurality of the drying sections 36 are provided so as to be arranged in the width direction X. The gas intake port 61 is provided on a downstream side of the plurality of the drying sections 36 in the transport direction D. According to this configuration, liquid evaporated from the medium 90 dried by the plurality of drying sections 36 provided so as to be arranged in the width direction X can be taken in from the gas intake port 61. Therefore, it is possible to suppress the lowering of the drying efficiency of the medium 90 and to dry the medium 90 without lowering the recording quality of the medium 90.

(2-2) The blower section 65 includes the blower port 66 that blows gas. The blower port 66 is provided on a upstream side of the plurality of the drying sections 36 in the transport direction D. According to this configuration, gas can be blown from the blower port 66 to the gas intake port 61. By this, when the medium 90 onto which liquid has been ejected is dried, it is possible to improve the gas intake efficiency of liquid evaporated from the medium 90. By this, it is possible to further suppress condensation of liquid evaporated from the medium 90. Therefore, it is possible to suppress the lowering of the drying efficiency of the medium 90 and to dry the medium 90 without lowering the recording quality of the medium 90.

(2-3) The gas intake port 61 opens up on an upstream side in the transport direction D. The blower port 66 opens up on a downstream side in the transport direction D. According to this configuration, when the medium 90 onto which liquid has been ejected is dried, the gas intake efficiency of liquid evaporated from the medium 90 can be improved. By this, it is possible to further suppress condensation of liquid evaporated from the medium 90. Therefore, it is possible to suppress the lowering of the drying efficiency of the medium 90 and to dry the medium 90 without lowering the recording quality of the medium 90.

(2-4) The first gas guide section 62 communicates with the gas intake port 61 and extends in the downstream direction with respect to the transport direction D. The second gas guide section 67 communicates with the blower port 66 and extends in the upstream direction with respect to the transport direction D. According to this configuration, gas can be blown from the second gas guide section 67 to the blower port 66 along the transport direction D. Gas can be taken in from the gas intake port 61 to the first gas guide section 62 along the transport direction D. Therefore, when the medium 90 onto which liquid has been ejected is dried, the gas intake efficiency of liquid evaporated from the medium 90 can be improved. By this, it is possible to further suppress condensation of liquid evaporated from the medium 90. Therefore, it is possible to suppress the lowering of the drying efficiency of the medium 90 and to dry the medium 90 without lowering the recording quality of the medium 90.

(2-5) The gas intake port 61 and the blower port 66 are provided at positions separated from the medium 90 in the vertical direction Z. According to this configuration, at a position separated from the medium 90, gas from the blower port 66 is blown, and gas is taken into the gas intake port 61. By this, it is possible to prevent a region where the medium 90 is dried by the drying section 36 from being cooled by the gas blown from the blower port 66 and gas taken into the gas intake port 61. Therefore, it is possible to suppress the lowering of the drying efficiency of the medium 90 and to dry the medium 90 without lowering the recording quality of the medium 90.

(2-6) The gas intake port 61 and the blower port 66 are provided on a front surface 90A side of the medium 90 onto which liquid is ejected in the vertical direction Z. The drying section 36 is provided on a back surface 90B side of the medium 90 in the vertical direction Z. According to this configuration, liquid evaporated from the front surface 90A of the medium 90 can be taken in from the gas intake port 61. Therefore, when the medium 90 onto which liquid has been ejected is dried, the gas intake efficiency of liquid evaporated from the medium 90 can be improved. By this, it is possible to further suppress condensation of liquid evaporated from the medium 90. Therefore, it is possible to suppress the lowering of the drying efficiency of the medium 90 and to dry the medium 90 without lowering the recording quality of the medium 90.

Since the drying section 36 is provided on a back surface 90B side of the medium 90, even if the drying section 36 comes into contact with the medium 90, liquid ejected onto the medium 90 is less likely to cling to the drying section 36. Therefore, the distance between the drying section 36 and the medium 90 can be shortened. Therefore, the drying efficiency of the medium 90 can be improved, and the medium 90 can be dried without lowering the recording quality of the medium 90.

### Third Embodiment

Next, a third embodiment will be described.

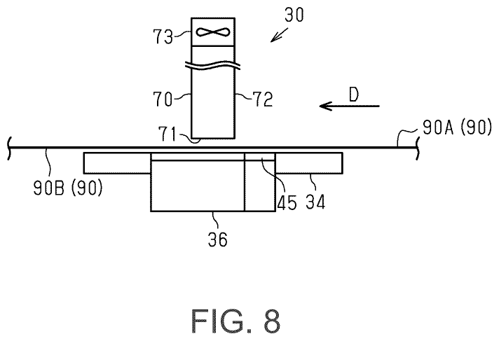

As shown in FIG. 8, in the third embodiment, the drying unit 30 may include a gas intake section 70. The gas intake section 70 includes a gas intake port 71, a gas intake pipe 72, and a gas intake fan 73. The gas intake port 71 is provided on a front surface 90A side of the medium 90 in the vertical direction Z. The gas intake port 71 is provided at a position overlapping the drying section 36 in plan view from the vertical direction Z. The gas intake port 71 is provided at a predetermined position away from the front surface 90A of the medium 90 in the vertical direction Z.

### Operations and Effect of Third Embodiment

Operations and a effect of the third embodiment will be described.

(3-1) The gas intake port 71 is provided on a front surface 90A side of the medium 90 onto which liquid is ejected in the vertical direction Z. The drying section 36 is provided on a back surface 90B side of the medium 90 in the vertical direction Z. The gas intake port 71 is provided at a position overlapping the drying section 36 in plan view from the vertical direction Z. According to this configuration, the drying efficiency of the medium 90 can be improved with a simple configuration without causing an increase in the size of the drying device 12.

### Modifications

The present embodiment can be implemented with the following modifications. The present embodiment and the following modifications can be implemented in combination with each other within a technically compatible range.

In the first embodiment, the drying unit 30 may include a plurality of drying sections 36. The plurality of drying sections 36 may be provided in the drying carriage 38.

In the first embodiment, the drying section 36 may be arranged so that the depth direction Y is a longitudinal direction. In the first embodiment, the drying section 36 may be arranged so as to be inclined with respect to the width direction X and the depth direction Y.

In the first embodiment, the switching valve 58 may include a first switching valve and a second switching valve. The first switching valve is provided in the first gas intake pipe 54. The first switching valve is a valve that opens and closes the first gas intake pipe 54. The second switching valve is provided in the second gas intake pipe 55. The second switching valve is a valve that opens and closes the second gas intake pipe 55. The control section 35 may open the first switching valve and close the second switching valve to take in gas from the first gas intake port 51. The control section 35 may close the first switching valve and open the second switching valve to take in gas from the second gas intake port 52.

In the first embodiment, the gas intake section 37 may be configured such that the first gas intake pipe 54 and the second gas intake pipe 55 do not intersect with each other. In this case, the gas intake section 37 may include a first gas intake fan communicating with the first gas intake pipe 54 and a second gas intake fan communicating with the second gas intake pipe 55. The gas intake section 37 may not include the switching valve 58. The control section 35 may control either the first gas intake fan or the second gas intake fan so as to take in gas from a gas intake port positioned in a direction opposite to a movement direction of the drying carriage 38.

In the first embodiment, the drying section 36 may be provided on a back surface 90B side of the medium 90. In this case, the drying device 12 may include a first drying carriage for moving the drying section 36 and a second drying carriage for moving the gas intake section 37. In the first embodiment, the drying section 36, the gas intake section 37, and the drying carriage 38 may be provided on a back surface 90B side of the medium 90.

In the first embodiment, the drying section 36 and the gas intake section 37 may be provided in the recording carriage 25 instead of the drying carriage 38. That is, the drying section 36 and the gas intake section 37 may be provided in a carriage which is movable in the width direction X. The recording carriage 25 may be an example of a carriage.

In the second embodiment and the third embodiment, the plurality of drying sections 36 may be arranged in a plurality of rows in the depth direction Y in addition to the width direction X. In the second embodiment and the third embodiment, each of the plurality of drying sections 36 may be arranged so that the width direction X is a longitudinal direction. In the second embodiment and the third embodiment, each of the plurality of drying sections 36 may be arranged so that the depth direction Y is a longitudinal direction.

In the second embodiment, the gas intake port 61 may be provided at a position overlapping the drying section 36 in plan view from the vertical direction Z. In a plan view from the vertical direction Z, the blower port 66 may be provided at a position overlapping with the drying section 36. In this case, it is possible to shorten the distance between the blower port 66 and the gas intake port 61 in the depth direction Y. By this, it is possible to prevent a region where the medium 90 is dried by the drying section 36 from being cooled by the gas blown from the blower port 66 and gas taken into the gas intake port 61. Therefore, it is possible to suppress the lowering of the drying efficiency of the medium 90 and to dry the medium 90 without lowering the recording quality of the medium 90.

In the second embodiment, the gas intake section 60 may include another communication member between the first gas guide section 62 and the gas intake fan 63. The blower section 65 may include another communication member between the second gas guide section 67 and the blower fan 68. These communication members may not necessarily extend along the transport direction D, and may extend along the vertical direction Z, for example.

In the second embodiment, the first gas guide section 62 may not have a linear shape along the transport direction D, and may be provided in, for example, an L-shape. The first gas guide section 62 is desirably configured to include a portion extending toward a downstream side in the transport direction D. In the second embodiment, the second gas guide section 67 may not have a linear shape along the transport direction D, and may be provided in an L-shape. The second gas guide section 67 is desirably configured to include a portion extending toward an upstream side in the transport direction D.

In the second embodiment, the blower section 65 may be provided on a downstream side of the drying section 36 in the transport direction D. In this case, the gas intake section 60 may be provided on an upstream side of the drying section 36 in the transport direction D.

The drying section 36 may be provided separately from the facing section 45. That is, the drying section 36 may not include the facing section 45. In this case, it is desirable for the facing section 45 to be provided between the first electrode 41 and the second electrode 42, and the medium 90.

At least one of the first electrode 41 and the second electrode 42 is not limited to a flat plate shape, and may be a substantially flat plate shape, for example. The substantially flat plate shape has, for example, a shape curved in the thickness direction that is a direction along the vertical direction Z or a rectangular shape having an extremely large aspect ratio, and may include a linear shape.

The drying section 36 may not be provided in the drying device 12 and may be provided in the recording device 11. That is, the recording device 11 may include the drying section 36. In this case, it is sufficient that the drying section 36 is provided on a downstream side of the recording section 20 in the transport direction D. In this manner, the drying section 36 may be applied to the recording device 11 instead of the drying device 12.

A lateral type printer may be adopted as the recording device 11. A lateral type printer is a printer in which the recording carriage 25 can move in two directions of a main scanning direction and a sub-scanning direction.

The medium 90 is not limited to a roll body. The medium 90 may be a paper sheet, a resin film or sheet, a resin-metal composite film, a laminate film, a textile, a nonwoven fabric, a metal foil, a metal film, a ceramic sheet, a garment, or the like.

Liquid can be arbitrarily selected as long as recording can be performed on the medium 90 by depositing the liquid to the medium 90. For example, ink includes an ink in which particles of a functional material made of a solid material such as a pigment or metal particles are dissolved, dispersed, or mixed in a solvent, and includes various compositions such as water-based ink, oil-based ink, gel ink, and hot melt ink.

As used herein, the phrase “at least any” means one or more of the desired options. As an example, the phrase “at least any” as used herein means only one option if the number of options is two, or both of the two options. As another example, the phrase “at least any” as used herein means only one option or a combination of any two or more options when the number of options is three or more.

### Notes

Hereinafter, technical ideas grasped from the above-described embodiments and modifications, and operations and effects thereof will be described. The present technical ideas and the operations and effects thereof can be combined with each other within a technically consistent range.

(A) A drying device includes a drying section that dries a medium onto which liquid was ejected, by generating an electromagnetic wave in response to application of a high-frequency voltage and a gas intake section that takes in gas, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the gas intake section includes a gas intake port that takes in gas evaporated from a medium onto which liquid has been ejected.

According to this configuration, when a medium onto which liquid has been ejected is dried, liquid evaporated from the medium is taken in intake port, so that condensation of the liquid evaporated from the medium can be suppressed. By this, it is possible to prevent condensed liquid from falling on a medium. Therefore, a medium can be dried without lowering the recording quality of the medium.

(B) The above-described drying device may be configured such that the gas intake port is provided at a position that does not overlap the drying section in plan view from the first direction.

According to this configuration, in plan view from the first direction, a region in which a medium is dried by the drying section and a region in which gas is taken in from the gas intake port can be configured so as not to overlap. This makes it possible to prevent a region in which a medium is dried by the drying section from being cooled by gas taken in through the gas intake port. Therefore, it is possible to suppress a decrease in the drying efficiency of a medium and to dry the medium without decreasing the recording quality of the medium.

(C) The above-described drying device may be configured such that the drying device further includes a carriage configured to move in a second direction intersecting the first direction, wherein the drying section and the gas intake section are provided on the carriage.

According to this configuration, by moving the carriage provided with the drying section and the gas intake section in the second direction, it is possible to improve the drying efficiency of a medium while reducing the number of drying sections without causing an increase in the size of the drying section and the gas intake section.

(D) The above-described drying device may be configured such that the gas intake port includes a first gas intake port and a second gas intake port, the first gas intake port and the second gas intake port are provided at positions that do not overlap the drying section in plan view from the first direction, and the drying section is provided between the first gas intake port and the second gas intake port in the second direction.

According to this configuration, the first gas intake port and the second gas intake port can be provided on both sides with respect to a movement direction of the drying section. By this, liquid evaporated from a medium in the movement direction of the drying section can be efficiently taken in. Therefore, a medium can be dried without lowering the recording quality of the medium.

(E) The above-described drying device may be configured such that the drying device further includes a control section that controls the gas intake section and the carriage, wherein in a case where the control section causes the carriage to move along the second direction, the control section controls the gas intake section so as to take in gas from, of the first gas intake port and the second gas intake port, the gas intake port positioned in a direction opposite to a movement direction of the carriage.

According to this configuration, it is possible to take in gas from the gas intake port positioned in a direction opposite to the movement direction of the drying section. By this, liquid evaporated from a medium in a direction opposite to the movement direction of the drying section can be efficiently taken in. Therefore, a medium can be dried without lowering the recording quality of the medium.

(F) The above-described drying device may be configured such that the gas intake section includes a switching valve that switches between taking in gas from the first gas intake port and taking in gas from the second gas intake port and in a case where the control section causes the carriage to move along the second direction, the control section controls the switching valve so as to take in gas from, of the first gas intake port and the second gas intake port, the gas intake port positioned in a direction opposite to a movement direction of the carriage.

According to this configuration, it is possible to switch by the control of the switching valve whether gas is taken in from the first gas intake port or gas is taken in from the second gas intake port. By this, liquid evaporated from a medium in a direction opposite to the movement direction of the drying section can be efficiently taken in. Therefore, a medium can be dried without lowering the recording quality of the medium.

(G) The above-described drying device may be configured such that the drying device includes a plurality of the drying sections, the plurality of the drying sections are provided so as to be arranged in a second direction intersecting the first direction, and the gas intake port is provided on a downstream side of the plurality of the drying sections in a medium transport direction.

According to this configuration, it is possible to take in liquid evaporated from a medium dried by the plurality of the drying sections provided so as to be arranged in the second direction from the gas intake port. Therefore, it is possible to suppress a decrease in the drying efficiency of a medium and to dry the medium without decreasing the recording quality of the medium.

(H) The above-described drying device may be configured such that the drying device further includes a blower section that blows gas, wherein the blower section includes a blower port for blowing gas and the blower port is provided on an upstream side of the plurality of the drying sections in the medium transport direction.

According to this configuration, gas can be blown from the blower port to the gas intake port. By this, when a medium onto which liquid has been ejected is dried, the gas intake efficiency of liquid evaporated from the medium can be improved. By this, it is possible to further suppress condensation of liquid evaporated from a medium. Therefore, it is possible to suppress a decrease in the drying efficiency of a medium and to dry the medium without decreasing the recording quality of the medium.

(I) The above-described drying device may be configured such that the gas intake port opens up at an upstream side in the medium transport direction and the blower port opens up at a downstream side in the medium transport direction.

According to this configuration, when a medium onto which liquid has been ejected is dried, the gas intake efficiency of liquid evaporated from the medium can be improved. By this, it is possible to further suppress condensation of liquid evaporated from a medium. Therefore, it is possible to suppress a decrease in the drying efficiency of a medium and to dry the medium without decreasing the recording quality of the medium.

(J) The above-described drying device may be configured such that the gas intake section includes a first gas guide section, the blower section includes a second gas guide section, the first gas guide section communicates with the gas intake port and extends in a downstream direction with respect to the medium transport direction, and the second gas guide section communicates with the blower port and extends in an upstream direction with respect to the medium transport direction.

According to this configuration, gas can be blown from the second gas guide section to the blower port along the medium transport direction. It is possible to take in gas from the gas intake port to the first gas guide section along the medium transport direction. Therefore, when a medium onto which liquid has been ejected is dried, the gas intake efficiency of liquid evaporated from the medium can be improved. By this, it is possible to further suppress condensation of liquid evaporated from a medium. Therefore, it is possible to suppress a decrease in the drying efficiency of a medium and to dry the medium without decreasing the recording quality of the medium.

(K) The above-described drying device may be configured such that the gas intake port and the blower port are provided at positions separated from a medium in the first direction.

According to this configuration, at positions separated from a medium, gas from the blower port is blown, and gas is taken into the gas intake port. This makes it possible to prevent a region in which a medium is dried by the drying section from being cooled by gas blown from the blower port and gas taken into the gas intake port. Therefore, it is possible to suppress a decrease in the drying efficiency of a medium and to dry the medium without decreasing the recording quality of the medium.

(L) The above-described drying device may be configured such that the gas intake port and the blower port are provided on a front surface side of a medium onto which liquid is ejected in the first direction and the drying section is provided on a back surface side opposite to the front surface in the first direction.

According to this configuration, liquid evaporated from a front surface of a medium can be taken in from the gas intake port. Therefore, when a medium onto which liquid has been ejected is dried, the gas intake efficiency of liquid evaporated from the medium can be improved. By this, it is possible to further suppress condensation of liquid evaporated from a medium. Therefore, it is possible to suppress a decrease in the drying efficiency of a medium and to dry the medium without decreasing the recording quality of the medium.

Since the drying section is provided on a back surface side, even when the drying section comes into contact with a medium, liquid ejected onto the medium is less likely to cling to the drying section. Therefore, the distance between the drying section and the medium can be shortened. Therefore, the drying efficiency of the medium can be improved, and the medium can be dried without lowering the recording quality of the medium.

(M) The above-described drying device may be configured such that the gas intake port is provided on a front surface side of a medium onto which liquid is ejected in the first direction, the drying section is provided on a back surface side opposite to the front surface in the first direction, and the gas intake port is provided at a position overlapping the drying section in plan view from the first direction.

According to this configuration, it is possible to improve the drying efficiency of a medium with a simple configuration without causing an increase in size of the drying device.

(N) A recording device includes a recording section that performs recording by ejecting liquid onto a medium; a drying section that dries a medium onto which liquid was ejected by the recording section, by generating an electromagnetic wave in response to application of a high-frequency voltage; and a gas intake section that takes in gas, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the gas intake section includes a gas intake port that takes in gas evaporated from a medium onto which liquid has been ejected.

According to this configuration, it is possible to achieve the same effect as (A).

What is claimed is:

1. A drying device comprising:
a drying section that dries a medium onto which liquid was ejected, by generating an electromagnetic wave in response to application of a high-frequency voltage and
a gas intake section that takes in gas, wherein the drying section includes
a first electrode,
a second electrode arranged so as to surround the first electrode in plan view from a first direction toward a medium,
a first conductor that includes a coil and that electrically connects a transmission line, which is configured to transmit a high-frequency voltage, and the first electrode, and
a second conductor that electrically connects the transmission line and the second electrode and
the gas intake section includes a gas intake port that takes in gas evaporated from a medium onto which liquid has been ejected.

2. The drying device according to claim 1, wherein
the gas intake port is provided at a position that does not overlap the drying section in plan view from the first direction.

3. The drying device according to claim 1, further comprising:
a carriage configured to move in a second direction intersecting the first direction, wherein
the drying section and the gas intake section are provided on the carriage.

4. The drying device according to claim 3, wherein
the gas intake port includes a first gas intake port and a second gas intake port,
the first gas intake port and the second gas intake port are provided at positions that do not overlap the drying section in plan view from the first direction, and
the drying section is provided between the first gas intake port and the second gas intake port in the second direction.

5. The drying device according to claim 4, further comprising:
a control section that controls the gas intake section and the carriage, wherein
in a case where the control section causes the carriage to move along the second direction, the control section controls the gas intake section so as to take in gas from, of the first gas intake port and the second gas intake port, the gas intake port positioned in a direction opposite to a movement direction of the carriage.

6. The drying device according to claim 5, wherein
the gas intake section includes a switching valve that switches between taking in gas from the first gas intake port and taking in gas from the second gas intake port and
in a case where the control section causes the carriage to move along the second direction, the control section controls the switching valve so as to take in gas from, of the first gas intake port and the second gas intake port, the gas intake port positioned in a direction opposite to a movement direction of the carriage.

7. The drying device according to claim 1, wherein
the drying device includes a plurality of the drying sections,
the plurality of the drying sections are provided so as to be arranged in a second direction intersecting the first direction, and
the gas intake port is provided on a downstream side of the plurality of the drying sections in a medium transport direction.

8. The drying device according to claim 7, further comprising:
a blower section that blows gas, wherein
the blower section includes a blower port for blowing gas and
the blower port is provided on an upstream side of the plurality of the drying sections in the medium transport direction.

9. The drying device according to claim 8, wherein
the gas intake port opens up at an upstream side in the medium transport direction and
the blower port opens up at a downstream side in the medium transport direction.

10. The drying device according to claim 9, wherein
the gas intake section includes a first gas guide section,
the blower section includes a second gas guide section,
the first gas guide section communicates with the gas intake port and extends in a downstream direction with respect to the medium transport direction, and
the second gas guide section communicates with the blower port and extends in an upstream direction with respect to the medium transport direction.

11. The drying device according to claim 8, wherein
the gas intake port and the blower port are provided at positions separated from a medium in the first direction.

12. The drying device according to claim 11, wherein
the gas intake port and the blower port are provided on a front surface side of a medium onto which liquid is ejected in the first direction and
the drying section is provided on a back surface side opposite to the front surface in the first direction.

13. The drying device according to claim 1, wherein
the gas intake port is provided on a front surface side of a medium onto which liquid is ejected in the first direction,
the drying section is provided on a back surface side opposite to the front surface in the first direction, and
the gas intake port is provided at a position overlapping the drying section in plan view from the first direction.

14. A recording device comprising:
a recording section that performs recording by ejecting liquid onto a medium;
a drying section that dries a medium onto which liquid was ejected by the recording section, by generating an electromagnetic wave in response to application of a high-frequency voltage; and
a gas intake section that takes in gas, wherein the drying section includes
a first electrode,
a second electrode arranged so as to surround the first electrode in plan view from a first direction toward a medium,
a first conductor that includes a coil and that electrically connects a transmission line, which is configured to transmit a high-frequency voltage, and the first electrode, and
a second conductor that electrically connects the transmission line and the second electrode and
the gas intake section includes a gas intake port that takes in gas evaporated from a medium onto which liquid has been ejected.
